(19) United States
(12) Patent Application Publication
(10) Pub. No.: US 2018/0283637 A1
(43) Pub. Date: Oct. 4, 2018

(54) LIGHTING DEVICE, VEHICLE HEADLAMP, AND VEHICLE

(71) Applicant: Panasonic Intellectual Property Management Co., Ltd., Osaka (JP)

(72) Inventors: Masanobu MURAKAMI, Osaka (JP); Takahiro FUKUI, Osaka (JP); Takahiro OHORI, Osaka (JP)

(21) Appl. No.: 15/936,779

(22) Filed: Mar. 27, 2018

(30) Foreign Application Priority Data
Mar. 30, 2017 (JP) 2017-069096

(51) Int. Cl. F21S 41/19; F21S 41/141; H05B 33/08

(52) U.S. Cl. CPC F21S 41/19; H05B 33/0842; F21S 41/141

(57) ABSTRACT

The lighting device lights an illumination load in which a first light source block and a second light source block are coupled in series. The lighting device includes a switch unit coupled in parallel with the second light source block. The switch unit includes a series circuit of a switching element and a resistor. The lighting device keeps the switching element off to set a state of the illumination load to a first state. The lighting device keeps the switching element on to set the state of the illumination load to a second state. The resistor has its resistance allowing a value of a voltage across the switch unit to be smaller than a value of a voltage across the second light source block which causes the second light source block to light while the switching element is on.

### CROSS-REFERENCE TO RELATED APPLICATIONS

The present application is based upon and claims the benefit of priority of Japanese Patent Application No. 2017-069096, filed on Mar. 30, 2017, the entire contents of which are incorporated herein by reference.

### TECHNICAL FIELD

The present disclosure relates to lighting devices, vehicle headlamps, and vehicles.

### BACKGROUND ART

Lighting devices used for applications such as headlamps normally can change the number of light sources to be on of multiple light sources, in order to switch between at least a running headlamp mode (high beam mode) and a passing headlamp mode (low beam mode).

This type of lighting device may be exemplified by a known device which uses a plurality of light sources connected in series and a switching element connected in parallel with first light source(s) of the light sources and in series with second light source(s) of the light sources (see e.g., Document 1 [JP 2004-136719 A]). To turn off the first light source(s) but turn on the second light source(s), the lighting device disclosed in Document 1 changes the switching element to an on-state (conduction state) to make a short circuit across the first light source(s). Although this configuration does not need lighting circuit for individual light sources, it can switch one or some of the light sources between an on-state and an off-state.

According to the configuration disclosed in Document 1, when some of light sources (illumination loads) are turned off by turning on the switching element, the number of light sources coupled in series between output ends of a lighting circuit (power conversion circuit) decreases. This causes decrease in the load voltage necessary for lighting. However, for example, a capacitor on an output side of the lighting circuit may cause increase in time necessary for an output voltage to decrease to a desired value from time of turning on the switching element. As a result, immediately after the switching element is turned on, an excessive load current is likely to flow through the light sources which are lighting. Such an excessive load current may cause failures of solid light emitting elements such as light emitting diodes (LEDs).

Alternatively, when the switching element is turned off to light all the light sources, the number of light sources coupled in series between the output ends of the lighting circuit increases. This causes increase in the load voltage necessary for lighting. However, as described above, the capacitor on the output side of the lighting circuit may cause increase in time necessary for the output voltage to increase to a desired value from time of turning off the switching element. As a result, immediately after the switching element is turned off, no load current flows through the light sources and this may cause instant decrease in luminance.

Further, when one or more of the light sources are turned off, said one or more of the light sources may cause slight light emission due to circuit configurations. Therefore, in the case where one or more of the light sources are turned off, it is required to suppress slight light emission of said one or more of the light sources.

An object of the present disclosure would be to propose a lighting device, a vehicle headlamp, and a vehicle which can suppress an overcurrent state of a load current and instant decrease in luminance which would otherwise occur when switching between on and off states one or more light sources of a plurality of light sources coupled in series with each other, and can suppress, when turning off one or more light sources, the one or more light sources from causing slight light emission.

### SUMMARY

A lighting device according to one aspect of the present disclosure is for lighting an illumination load in which a first light source block including one or more first light sources and a second light source block including one or more second light sources are coupled in series with each other. The lighting device includes: a power conversion circuit; a switching circuit; and a control circuit. The power conversion circuit is configured to supply a DC load current to the illumination load. The switching circuit includes a switch unit to be coupled in parallel with the second light source block. The switch unit includes a series circuit of a switching element and a resistor. The control circuit is configured to keep the switching element off to change a state of the illumination load to a first state. The first state is a state of the illumination load where the first light source block and the second light source block are lit. Further, the control circuit is configured to keep the switching element on to change the state of the illumination load to a second state. The second state is a state of the illumination load where the first light source block is lit and the second light source is extinguished. A resistance of the resistor is set to allow a value of a voltage across the switch unit to be smaller than a value of a voltage across the second light source block which causes the second light source block to light while the switching element is on.

A vehicle headlamp according to one aspect of the present disclosure includes: the aforementioned lighting device; a lamp body where the lighting device is attached; and the illumination load to be lit by the lighting device.

A vehicle according to one aspect of the present disclosure includes: the aforementioned vehicle headlamp; and a vehicle body where the vehicle headlamp is mounted.

### BRIEF DESCRIPTION OF THE DRAWINGS

The figures depict one or more implementation in accordance with the present teaching, by way of example only, not by way of limitations. In the figures, like reference numerals refer to the same or similar elements.

FIG. 1 is a block diagram of a lighting device of EMBODIMENT 1.

FIG. 2 is a circuit diagram of part of configurations of a comparative example of EMBODIMENT 1.

FIG. 3A is a waveform chart of an output voltage of the comparative example of EMBODIMENT 1. FIG. 3B is a waveform chart of a load current of the comparative example of EMBODIMENT 1.

FIG. 4A is another waveform chart of the output voltage of the comparative example of EMBODIMENT 1. FIG. 4B is another waveform chart of the load current of the comparative example of EMBODIMENT 1.

FIG. 5A is a waveform chart of a driving voltage of EMBODIMENT 1. FIG. 5B is a waveform chart of an output voltage of EMBODIMENT 1. FIG. 5C is a waveform chart of a load current of EMBODIMENT 1.

FIG. 6A is another waveform chart of the driving voltage of EMBODIMENT 1. FIG. 6B is another waveform chart of the output voltage of EMBODIMENT 1. FIG. 6C is another waveform chart of the load current of EMBODIMENT 1.

FIG. 7A is a waveform chart of a driving voltage of a modification of EMBODIMENT 1. FIG. 7B is a waveform chart of an output voltage of the modification of EMBODIMENT 1.

FIG. 7C is a waveform chart of a load current of the modification of EMBODIMENT 1.

FIG. 8A is another waveform chart of the driving voltage of the modification of EMBODIMENT 1. FIG. 8B is a waveform chart of the output voltage of the modification of EMBODIMENT 1. FIG. 8C is another waveform chart of the load current of the modification of EMBODIMENT 1.

FIG. 9 is a block diagram of a lighting device of EMBODIMENT 2.

FIG. 10A is a waveform chart of an output voltage of EMBODIMENT 2. FIG. 10B is a waveform chart of a load current of EMBODIMENT 2.

FIG. 11A is another waveform chart of an output voltage of EMBODIMENT 2. FIG. 11B is another waveform chart of a load current of EMBODIMENT 2.

FIG. 12 is a section of configurations of a vehicle headlamp.

FIG. 13 is a perspective view of partial configurations of a vehicle.

### DETAILED DESCRIPTION

The following descriptions with reference to drawings are made to embodiments according to the present disclosure. The embodiments described below relate generally to lighting devices, vehicle headlamps, and vehicles. In more detail, the below-mentioned embodiments relate to a lighting device, a vehicle headlamp, and a vehicle for turning on and off one or more of a plurality of light sources coupled in series with each other.

### Embodiment 1

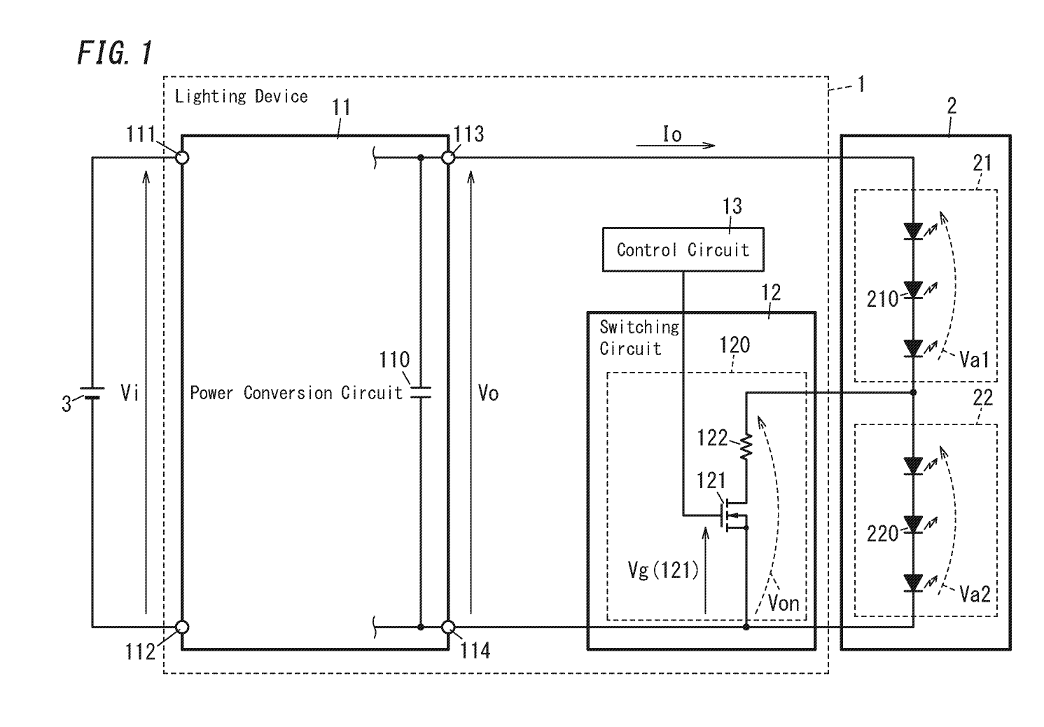

FIG. 1 shows a block configuration of a lighting device 1 of EMBODIMENT 1.

The lighting device 1 outputs DC power to an illumination load 2. The illumination load 2 is constituted by a plurality of LEDs (solid light emitting devices) each serving as a light source, and thus includes a first light source block 21 and a second light source block 22.

The first light source block 21 includes a plurality of (three in FIG. 1) LEDs 210 electrically coupled in series with each other. Each of the plurality of LEDs 210 corresponds to a first light source. As to a pair of adjacent LEDs 210, a cathode of one of the LEDs 210 is electrically coupled to an anode of the other of the LEDs 210. The first light source block 21 has an anode side and a cathode side which serve as a high potential side and a low potential side, respectively. Note that, the number of LEDs 210 is not limited to three, but may be one or more.

The second light source block 22 includes a plurality of (three in FIG. 1) LEDs 220 electrically coupled in series with each other. Each of the plurality of LEDs 220 corresponds to a second light source. As to a pair of adjacent LEDs 220, a cathode of one of the LEDs 220 is electrically coupled to an anode of the other of the LEDs 220. The second light source block 22 has an anode side and a cathode side which serve as a high potential side and a low potential side, respectively. Note that, the number of LEDs 220 is not limited to three, but may be one or more.

The illumination load 2 is formed by electrically connecting the first light source block 21 and the second light source block 22 in series with each other. The cathode side of the first light source block 21 is electrically connected to the anode side of the second light source block 22. The anode side of the first light source block 21 serves as an anode side of the illumination load 2 and the cathode side of the second light source block 22 serves as a cathode side of the illumination load 2.

The lighting device 1 includes a power conversion circuit 11, a switching circuit 12, and a control circuit 13.

The power conversion circuit 11 receives DC power from a DC power supply 3 such as a battery by a pair of input ends 111 and 112, and outputs DC power via a pair of output ends 113 and 114. When an output voltage Vo is developed between the output ends 113 and 114, the output end 113 serves as a high potential side and the output end 114 serves as a low potential side (circuit ground side). The anode side of the illumination load 2 is electrically connected to the output end 113 and the cathode side of the illumination load 2 is electrically connected to the output end 114. Stated differently, the anode side of the first light source block 21 and the cathode side of the second light source block 22 receive the high potential side and the low potential side of the output voltage Vo, respectively.

The power conversion circuit 11 includes a DC/DC conversion circuit (DC/DC converter) for converting a DC voltage Vi of the DC power supply 3 into the DC output voltage Vo necessary to realize stable lighting of the illumination load 2. The DC/DC conversion circuit can be realized by known technique, and therefore detailed configurations of the power conversion circuit 11 are omitted. Note that, examples of general DC/DC conversion circuit may include a chopper circuit, a flyback converter, and a forward converter.

This type of the power conversion circuit 11 includes at least an inductor element, a switching element, a rectifier element, and a smoothing element (e.g., a capacitor 110), and chops power supplied to the inductor element from the DC power supply 3 by the switching element turned on and off at high frequency. Such switching operation of the switching element allows the power conversion circuit 11 to output energy via the rectifier element from the inductor element connected in series with the illumination load 2, and thereby increasing or decreasing the output voltage Vo relative to the DC voltage Vi. Examples of the inductor element may include an inductor (coil) and a transformer.

To realize stable lighting of the illumination load 2, the power conversion circuit 11 keeps a value of a current Io supplied to the illumination load 2 equal to a constant current target value Io1. Stated differently, the power conversion circuit 11 serves as a power supply circuit for adjusting the value of the current Io supplied to the illumination load 2 to the current target value Io1. Note that, hereinafter, the current Io supplied from the power conversion circuit 11 to the illumination load 2 serving as a load is referred to as a load current Io.

The power conversion circuit 11 includes the capacitor 110 for smoothing connected between the pair of output ends 113 and 114 on an output side thereof. The capacitor 110 serves to reduce ripples of the output voltage Vo.

While the power conversion circuit 11 is in operation, the lighting device 1 keeps the first light source block 21 of the illumination load 2 on, and keeps the second light source block 22 on or off. Stated differently, the lighting device 1 includes the switching circuit 12 and the control circuit 13, thereby switching the second light source block 22 between an on-state and an off-state while keeping the first light source block 21 on.

The switching circuit 12 includes a series circuit of a switching element 121 and a resistor 122, which serves as a switch unit 120. The switching element 121 is an N-channel enhancement metal oxide semiconductor field effect transistor (MOSFET). The resistor 122 has its one end electrically coupled to the anode side of the second light source block 22, and its other end electrically coupled to a drain of the switching element 121. The switching element 121 has its source electrically coupled to the cathode side of the second light source block 22. Note that, the switching element 121 may be any other transistor such as an insulated gate bipolar transistor (IGBT).

A driving voltage applied to a gate of the switching element 121 is designated by Vg(121). The control circuit 13 can turn on and off the switching element 121 by controlling a value of the driving voltage Vg(121). When the value of the driving voltage Vg(121) is equal to a positive voltage Vg1, an electric path is made between the drain and source of the switching element 121, and thereby the switching element 121 is turned to its on-state. When the value of the driving voltage Vg(121) is equal to 0 [V], the electric path is broken between the drain and source of the switching element 121, and thereby the switching element 121 is turned to its off-state. Note that, the positive voltage Vg1 is equal to or larger than an on-threshold voltage of the switching element 121.

The control circuit 13 controls the value of the driving voltage Vg(121) to be equal to 0 [V] to keep the switching element 121 off so that both the first light source block 21 and the second light source block 22 are lit. In this situation, the load current Io flows through the first light source block 21 and the second light source block 22 but does not flow through the switching circuit 12. Thus, both the first light source block 21 and the second light source block 22 are turned on. This state of the illumination load 2 where the first light source block 21 and the second light source block 22 both are lit is defined as a first state.

The control circuit 13 controls the value of the driving voltage Vg(121) to be equal to the positive voltage Vg1 to keep the switching element 121 so that the first light source block 21 is lit and the second light source block 22 is extinguished. In this situation, the load current Io flows from the first light source block 21 to not the second light source block 22 but the switching circuit 12. Thus, the first light source block 21 is turned on and the second light source block 22 is turned off. This state of the illumination load 2 where the first light source block 21 is lit and the second light source block 22 is extinguished is defined as a second state.

Hereinafter, detailed descriptions are made to operation of switching the second light source block 22 between on-state and off-state.

First, a value of a voltage across the first light source block 21 necessary for turning on the first light source block 21 is supposed to be a first load voltage value Va1. This first load voltage value Va1 is equal to or larger than a lighting start voltage value (barrier voltage value) of the first light source block 21. The lighting start voltage value of the first light source block 21 means a value of a forward voltage of the first light source block 21 which allows the first light source block 21 to start lighting. The lighting start voltage value of the first light source block 21 may be given by a sum of the lighting start voltage values of the plurality of LEDs 210 connected in series with each other. Stated differently, the lighting start voltage of the first light source block 21 is defined as a value of a voltage across the first light source block 21 which causes the first light source block 21 to start lighting.

Additionally, a value of a voltage across the second light source block 22 necessary for turning on the second light source block 22 is supposed to be a second load voltage value Va2. This second load voltage value Va2 is equal to or larger than a lighting start voltage value of the second light source block 22. The lighting start voltage value of the second light source block 22 means a value of a forward voltage of the second light source block 22 which allows the second light source block 22 to start lighting. The lighting start voltage value of the second light source block 22 may be given by a sum of the lighting start voltage values of the plurality of LEDs 220 connected in series with each other. Stated differently, the lighting start voltage of the second light source block 22 is defined as a value of a voltage across the second light source block 22 which causes the second light source block 22 to start lighting.

Since the power conversion circuit 11 keeps a value of the load current Io equal to the constant current target value Io1, a value of the output voltage Vo is equal to a sum (Va1+Va2) of the first load voltage value Va1 and the second load voltage value Va2 in a condition where both the first light source block 21 and the second light source block 22 are on (the first state). Additionally, a value of the output voltage Vo is equal to a sum (Va1+Von) of the first load voltage value Va1 and an on-voltage value Von of the switch unit 120 in a condition where only the first light source block 21 is on (the second state).

In this regard, the on-voltage value Von of the switch unit 120 is equal to a value of a voltage across a series circuit of the switching element 121 and the resistor 122 caused by a current with the current target value Io1 while the switching element 121 is on. Note that, an on-resistance of the switching element 121 is considerably smaller than a resistance of the resistor 122. For example, the on-resistance of the switching element 121 is 18 [me] and in contrast the resistance of the resistor 122 is set to 4 [a]. Therefore, when the switching element 121 is on, a value of a voltage across the switching element 121 is much smaller than a value of a voltage across the resistor 122, and thus the value of the voltage across the switching element 121 in its on-state can be considered to be 0. Hence, the on-voltage value Von may be considered to be equal to the value of the voltage across the resistor 122.

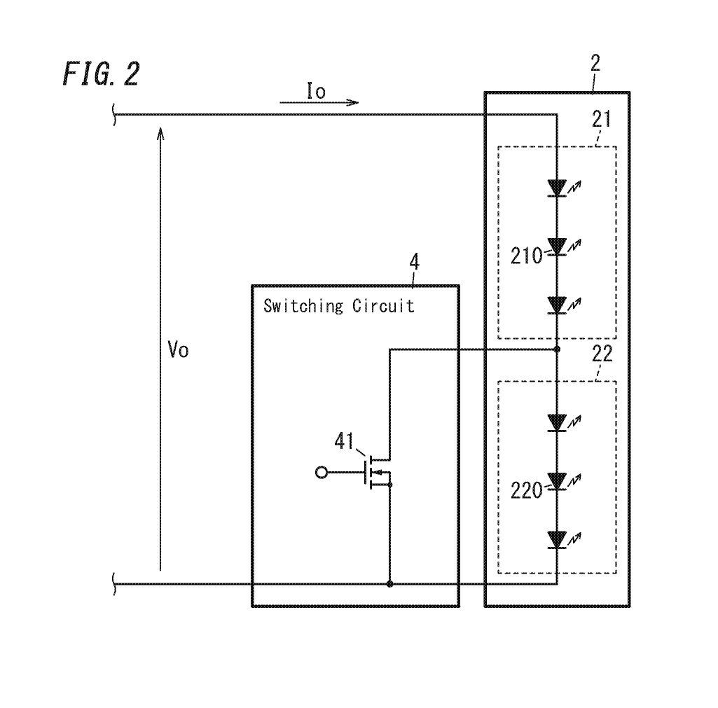

FIG. 2 shows configurations of a comparative example different from the lighting device 1 of the present embodiment. In the comparative example, a switching circuit 4 is electrically coupled in parallel with the second light source block 22. The switching circuit 4 includes a switching element 41 only, and the switching element 41 is electrically coupled in parallel with the second light source block 22. And, in the comparative example, both the first light source block 21 and the second light source block 22 are on while the switching element 41 is off. While the switching element 41 is on, the first light source block 21 is on but the second light source block 22 is off.

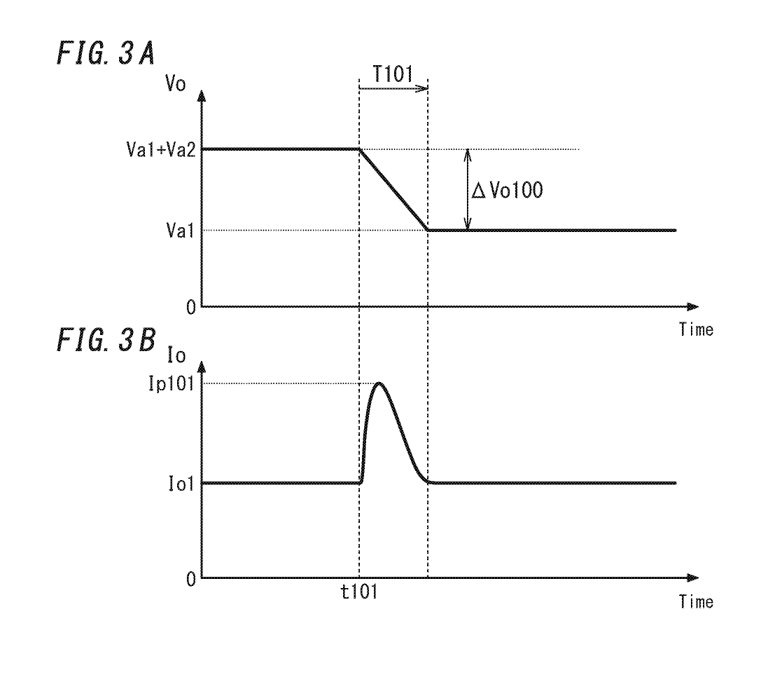

In this comparative example, as shown in FIG. 3A, when the switching element 41 is switched from its off-state to its on-state (at time point t101), the value of the output voltage Vo decreases from the sum (Va1+Va2) of the first load voltage value Va1 and the second load voltage value Va2 to the first load voltage value Va1. However, due to presence of the capacitor 110 coupled between the output ends 113 and 114 of the power conversion circuit 11, discharge time T101 is necessary for the value of the output voltage Vo to decrease to the first load voltage value Va1 after the switching element 41 is turned on. As a result, as shown in FIG. 3B, directly after the switching element 41 is turned on, the excessive load current Io is likely to flow through the LEDs 210 which are on. Such an excessive load current Io may cause failures of the LEDs 210.

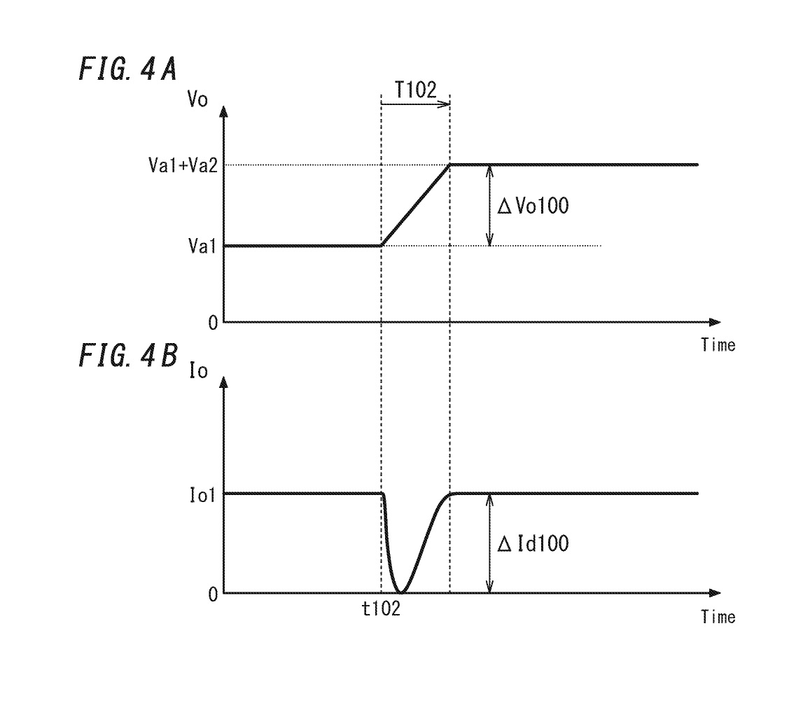

Additionally, as shown in FIG. 4A, when the switching element 41 is switched from its on-state to its off-state (at time point t102), the value of the output voltage Vo increases from the first load voltage value Va1 to the sum (Va1+Va2) of the first load voltage value Va1 and the second load voltage value Va2. However, due to presence of the capacitor 110, charge time T102 is necessary for the value of the output voltage Vo to increase to the sum (Va1+Va2) of the first load voltage value Va1 and the second load voltage value Va2 after the switching element 41 is turned off. As a result, as shown in FIG. 4B, directly after the switching element 41 is turned off, the value of the load current Io decreases instantly, which may cause instant decrease in luminance of the illumination load 2.

In view of such problems, as to the lighting device 1 of the present embodiment, the switching circuit 12 includes a series circuit of the switching element 121 and the resistor 122.

While the switching element 121 is on, the load current Io flows through the resistor 122 and therefore an on-voltage may develop across the switching circuit 12. The on-voltage value Von is equal to a product of the resistance of the resistor 122 and the value of the load current Io. In the present embodiment, the resistance of the resistor 122 is determined to allow the on-voltage value Von to be smaller than the lighting start voltage value of the second light source block 22.

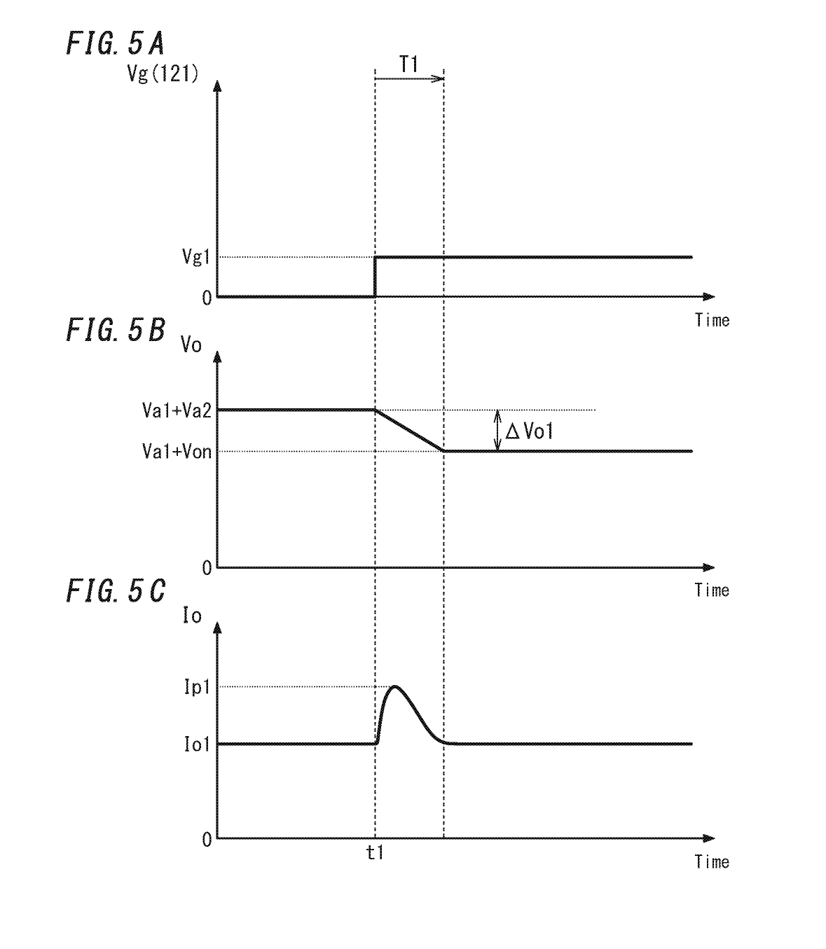

First, descriptions referring to FIG. 5A, FIG. 5B, and FIG. 5C are given to operation of switching the state of the illumination load 2 from the first state where both the first light source block 21 and the second light source block 22 are on to the second state where the first light source block 21 is on and the second light source block 22 is off. FIG. 5A shows a waveform of the driving voltage Vg(121). FIG. 5B shows a waveform of the output voltage Vo. FIG. 5C shows a waveform of the load current Io.

The control circuit 13 controls the value of the driving voltage Vg(121) to be equal to 0 [V] to turn off the switching element 121, thereby allowing both the first light source block 21 and the second light source block 22 to light. In this situation, the value of the output voltage Vo is equal to the sum (Va1+Va2) of the first load voltage value Va1 and the second load voltage value Va2, and the value of the load current Io is controlled to be equal to the constant current target value Io1.

Thereafter, the control circuit 13 changes the value of the driving voltage Vg(121) from 0 [V] to the positive voltage Vg1, thereby switching the switching element 121 from the off-state to the on-state (a time point t1). When the switching element 121 is switched from the off-state to the on-state, the value of the output voltage Vo decreases from the sum (Va1+Va2) of the first load voltage value Va1 and the second load voltage value Va2 to the sum (Va1+Von) of the first load voltage value Va1 and the on-voltage value Von. In FIG. 5B, the switching element 121 is turned on at the time point t1 and thus the capacitor 110 starts to discharge. After the discharge time T1 passes from the time point t1, the value of the output voltage Vo decreases to the sum (Va1+Von) of the first load voltage value Va1 and the on-voltage value Von.

In this regard, in FIG. 5B corresponding to the present embodiment, a voltage difference between the sum (Va1+Va2) of the first load voltage value Va1 and the second load voltage value Va2 and the sum (Va1+Von) of the first load voltage value Va1 and the on-voltage value Von is defined as ΔVo1 (=Va2−Von). Further, in FIG. 3A corresponding to the comparative example, a voltage difference between the sum (Va1+Va2) of the first load voltage value Va1 and the second load voltage value Va2 and the first load voltage value Va1 is defined as ΔVo100 (=Va2). Since the on-voltage value Von is smaller than the second load voltage value Va2, the voltage difference ΔVo1 is also smaller than the voltage difference ΔVo100. In summary, an amount of energy discharged from the capacitor 110 when the switching element is switched from the off-state to the on-state is smaller in the present embodiment than in the comparative example.

As a result, the value of the load current Io shows a rapid and drastic increase directly after the switching element 121 is turned on. However, in this situation, a current peak value Ip1 is smaller than a current peak value Ip101 shown in FIG. 3B. In summary, the current peak value of the load current Io flowing through the LEDs 210 directly after the switching element 121 is turned on can be made to be smaller in the present embodiment than in the comparative example, and therefore occurrence of failures of the LEDs 210 can be suppressed.

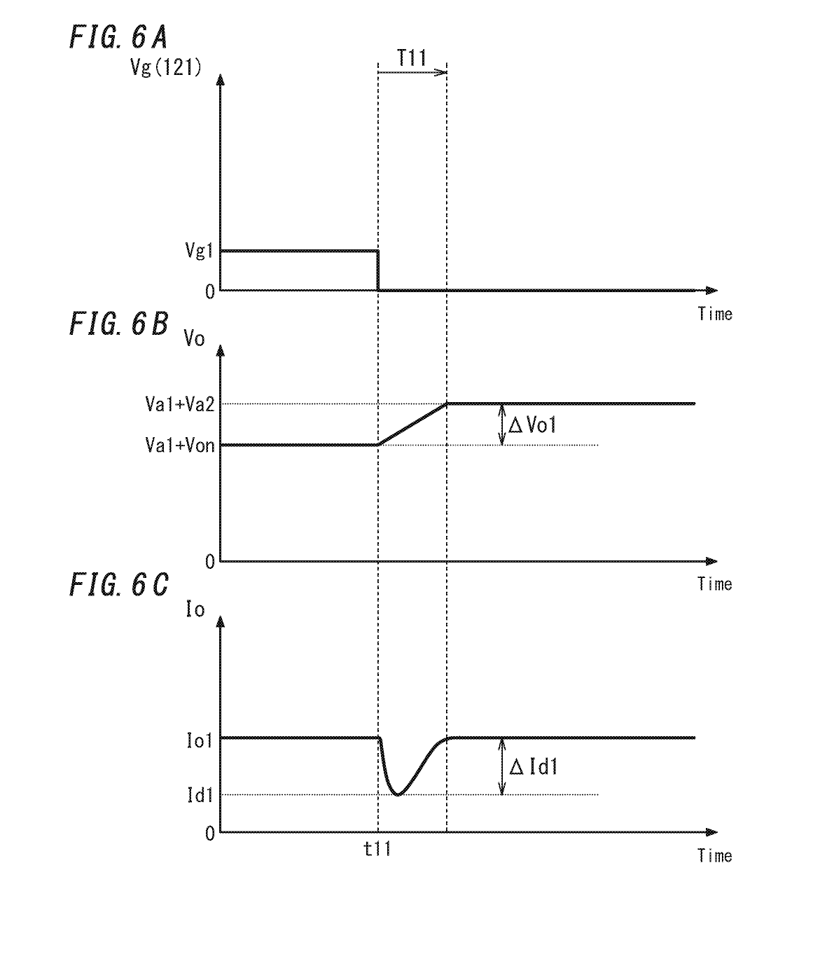

Next, descriptions referring to FIG. 6A, FIG. 6B, and FIG. 6C are given to operation of switching the state of the illumination load 2 from the second state where the first light source block 21 is on and the second light source block 22 is off to the first state where both the first light source block 21 and the second light source block 22 are on. FIG. 6A shows a waveform of the driving voltage Vg(121). FIG. 6B shows a waveform of the output voltage Vo. FIG. 6C shows a waveform of the load current Io.

The control circuit 13 controls the value of the driving voltage Vg(121) to be equal to the positive voltage Vg1 to turn on the switching element 121, thereby allowing the first light source block 21 to light and the second light source block 22 to be off. In this situation, the value of the output voltage Vo is equal to the sum (Va1+Von) of the first load voltage value Va1 and the on-voltage value Von, and the value of the load current Io is controlled to be equal to the constant current target value Io1.

Thereafter, the control circuit 13 changes the value of the driving voltage Vg(121) from the positive voltage Vg1 to 0 [V], thereby switching the switching element 121 from the on-state to the off-state (a time point t11). When the switching element 121 is switched from the on-state to the off-state, the value of the output voltage Vo increases from the sum (Va1+Von) of the first load voltage value Va1 and the on-voltage value Von to the sum (Va1+Va2) of the first load voltage value Va1 and the second load voltage value Va2. In FIG. 6B, the switching element 121 is turned off at the time point t11 and thus the capacitor 110 starts to be charged. After the charge time T11 passes from the time point t11, the value of the output voltage Vo increases to the sum (Va1+Va2) of the first load voltage value Va1 and the second load voltage value Va2.

In this regard, in FIG. 6B corresponding to the present embodiment, the voltage difference between the sum (Va1+Va2) of the first load voltage value Va1 and the second load voltage value Va2 and the sum (Va1+Von) of the first load voltage value Va1 and the on-voltage value Von is ΔVo1. Further, in FIG. 4A corresponding to the comparative example, the voltage difference between the sum (Va1+Va2) of the first load voltage value Va1 and the second load voltage value Va2 and the first load voltage value Va1 is ΔVo100. As described above, the voltage difference ΔVo1 is smaller than the voltage difference ΔVo100. Therefore, an amount of energy for compensating for shortage in energy stored in the capacitor 110 when the switching element is switched from the on-state to the off-state is smaller in the present embodiment than in the comparative example.

As a result, the value of the load current Io instantly decreases to a current minimum value Id1 directly after the switching element 121 is turned off. However, a current decrease amount ΔId1 defined as an amount of decrease in the load current Io is smaller than a current decrease amount ΔId100 defined as an amount of decrease in the load current Io shown in FIG. 4B. In summary, the amount of the decrease in the load current Io which occurs directly after the switching element 121 is turned off can be made to be smaller in the present embodiment than in the comparative example, and therefore instant decrease in luminance of the illumination load 2 can be suppressed.

Additionally, it is necessary not to allow a current to flow through the second light source block 22 while the switching element 121 is on. For this purpose, the resistance of the resistor 122 is set to allow a value of a voltage across the resistor 122 developed while the switching element 121 is on, to be smaller than the lighting start voltage value of the second light source block 22.

Accordingly, in a condition where the switching element 121 is on, the value of the voltage across the resistor 122 is smaller than the lighting start voltage value of the second light source block 22. Consequently, no current flows through the second light source block 22 and thus slight light emission of the second light source block 22 (the LEDs 220) can be suppressed.

As already mentioned above, the lighting device 1 can suppress an overcurrent state of the load current Io and instant decrease in luminance of the illumination load 2 which would otherwise occur when switching between the on-state and the off-state the second light source block 22 of the set of the first light source block 21 and the second light source block 22 coupled in series with each other. Additionally, the lighting device 1 can suppress slight light emission of the second light source block 22 (the LEDs 220) during off-control on the second light source block 22.

The following descriptions are made to a modification of EMBODIMENT 1. In the present modification, a switching time period for turning on and off the switching element 121 alternately is provided during transition of the state of the illumination load 2 between the first state to the second state.

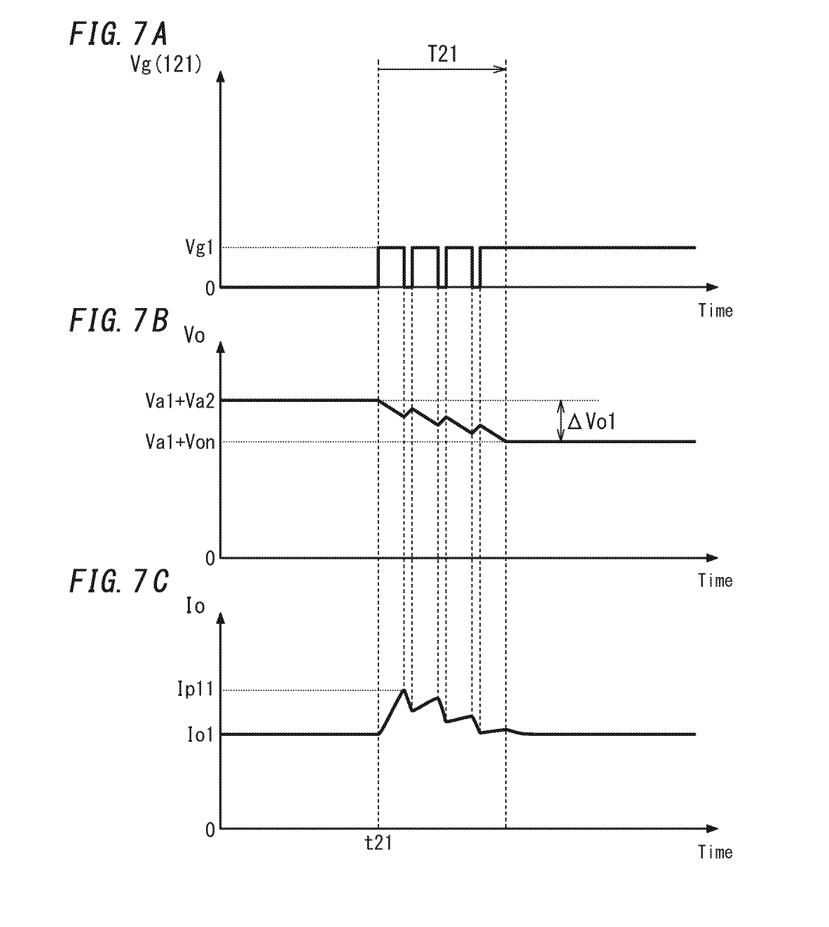

First, descriptions referring to FIG. 7A, FIG. 7B, and FIG. 7C are given to operation of switching the state of the illumination load 2 from the first state where both the first light source block 21 and the second light source block 22 are on to the second state where the first light source block 21 is on and the second light source block 22 is off. FIG. 7A shows a waveform of the driving voltage Vg(121). FIG. 7B shows a waveform of the output voltage Vo. FIG. 7C shows a waveform of the load current Io.

The control circuit 13 controls the value of the driving voltage Vg(121) to be equal to 0 [V] to turn off the switching element 121, thereby allowing both the first light source block 21 and the second light source block 22 to light. In this situation, the value of the output voltage Vo is equal to the sum (Va1+Va2) of the first load voltage value Va1 and the second load voltage value Va2, and the value of the load current Io is controlled to be equal to the constant current target value Io1.

Thereafter, the control circuit 13 changes the value of the driving voltage Vg(121) from 0 [V] to the positive voltage Vg1, thereby switching the state of the illumination load 2 from the first state to the second state. In the present modification, a switching time period (first switching time period) of turning on and off the switching element 121 alternately is provided during transition from the first state to the second state, of the illumination load 2. In this switching time period, the control circuit 13 performs, at least one time, switching control of switching the value of the driving voltage Vg(121) from 0 [V] to the positive voltage Vg1 and further switching it from the positive voltage Vg1 to 0 [V]. In this case, switching operation of switching the switching element 121 from the off-state to the on-state and subsequently switching it from the on-state to the off-state is performed at least one time. In summary, switching (turning on and off) the switching element 121 is performed at least one time while the state of the illumination load 2 is switched from the first state to the second state.

When the switching element 121 is switched from the off-state to the on-state, the value of the load current Io increases rapidly and drastically and thus the value of the output voltage Vo decreases (an on-time period). After that, before the value of the load current Io reaches the current peak value Ip1 (see FIG. 5C), the switching element 121 is switched from the on-state to the off-state. When the switching element 121 is switched from the on-state to the off-state, the value of the load current Io decreases, and the value of the output voltage Vo increases (an off-time period). Thereafter, the switching element 121 is switched from the off-state to the on-state, again. When the switching element 121 is switched from the off-state to the on-state, the value of the load current Io increases again and the value of the output voltage Vo decreases again. The control circuit 13 sets the off-time period of the switching element 121 to be shorter than the on-time period. The control circuit 13 repeats the switching operation of the switching element 121 described above. As a result, the current peak value of the load current Io is suppressed not to exceed Ip11, and the value of the output voltage Vo gradually decreases, and reaches the sum (Va1+Von) of the first load voltage value Va1 and the on-voltage value Von eventually. In FIG. 7B, the switching operation of the switching element 121 is started at a time point t21, and thus the capacitor 110 gradually discharges. After discharge time T21 passes from the time point t21, the value of the output voltage Vo decreases to the sum (Va1+Von) of the first load voltage value Va1 and the on-voltage value Von.

After that, the control circuit 13 keeps the value of the driving voltage Vg(121) equal to the positive voltage Vg1 to keep the switching element 121 on. Thereby the first light source block 21 is lit and the second light source block 22 is extinguished.

In switching the state of the illumination load 2 from the first state to the second state, the control circuit 13 can perform the switching operation of the switching element 121 with a predetermined period a predetermined number of times. The period and the number of times can be determined so that switching of the switching element 121 is performed over the charge time T21 to allow suppressing the current peak value of the load current Io and decreasing the value of the output voltage Vo from (Va1+Va2) to (Va1+Von).

Additionally, the control circuit 13 may measure the value of the output voltage Vo. In this regard, in switching the state of the illumination load 2 from the first state to the second state, the control circuit 13 switches the switching element 121 from the off-state to the on-state when an amount of increase in the output voltage Vo in a condition where the switching element 121 is off (a difference between values of the output voltage Vo before and after increase in the output voltage Vo) reaches a predetermined value during the switching operation of the switching element 121. The control circuit 13 repeats turning on and off the switching element 121 as described above until the value of the output voltage Vo decreases from (Va1+Va2) to (Va1+Von).

Accordingly, while switching the second light source block 22 (the LEDs 220) from the lighting state to the extinguished state, the lighting device 1 can more decrease the current peak value of the load current Io.

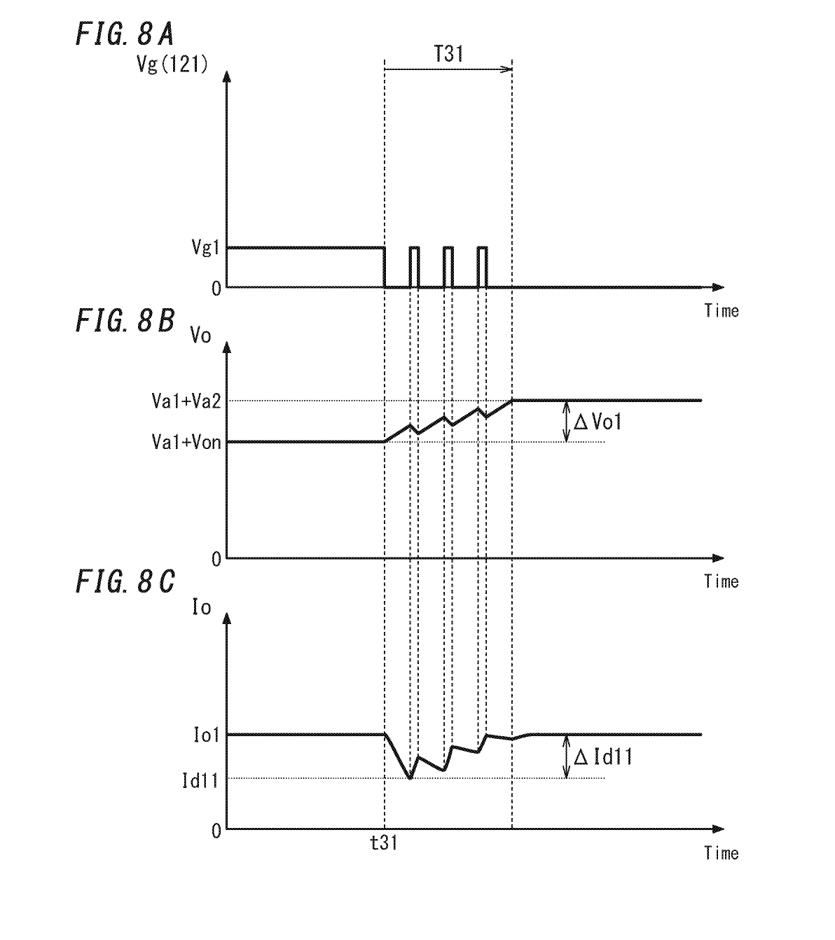

Next, descriptions referring to FIG. 8A, FIG. 8B, and FIG. 8C are given to operation of switching the state of the illumination load 2 from the second state where the first light source block 21 is on and the second light source block 22 is off to the first state where both the first light source block 21 and the second light source block 22 are on. FIG. 8A shows a waveform of the driving voltage Vg(121). FIG. 8B shows a waveform of the output voltage Vo. FIG. 8C shows a waveform of the load current Io.

The control circuit 13 controls the value of the driving voltage Vg(121) to be equal to the positive voltage Vg1 [V] to turn on the switching element 121, thereby allowing the first light source block 21 to light and the second light source block 22 to be off. In this situation, the value of the output voltage Vo is equal to the sum (Va1+Von) of the first load voltage value Va1 and the on-voltage value Von, and the value of the load current Io is controlled to be equal to the constant current target value Io1.

Thereafter, the control circuit 13 changes the value of the driving voltage Vg(121) from the positive voltage Vg1 to 0 [V], thereby switching the state of the illumination load 2 from the second state to the first state. In the present modification, a switching time period of turning on and off the switching element 121 (second switching time period) alternately is provided during transition from the second state to the first state, of the illumination load 2. In this switching time period, the control circuit 13 performs, at least one time, switching control of switching the value of the driving voltage Vg(121) from the positive voltage Vg1 to 0 [V] and further switching it from 0 [V] to the positive voltage Vg1. In this case, switching operation of switching the switching element 121 from the on-state to the off-state and subsequently switching it from the off-state to the on-state is performed at least one time. In summary, switching (turning on and off) the switching element 121 is performed at least one time while the state of the illumination load 2 is switched from the second state to the first state.

When the switching element 121 is switched from the on-state to the off-state, the value of the load current Io decreases rapidly and drastically and thus the value of the output voltage Vo increases (an off-time period). Decrease in the value of the load current Io may cause decrease in luminance of the first light source block 21. However, before such decrease in luminance becomes larger to an extent that the decrease can be sensed by human eyes (that is, an amount of decrease in the load current Io is excess), the switching element 121 is switched from the off-state to the on-state and therefore the minimum value of the load current Io is equal to Id11. When the switching element 121 is switched from the off-state to the on-state, the value of the load current Io increases, and the value of the output voltage Vo decreases (an on-time period). Thereafter, the switching element 121 is switched from the on-state to the off-state, again. When the switching element 121 is switched from the on-state to the off-state, the value of the load current Io decreases again and the value of the output voltage Vo increases again. The control circuit 13 sets the on-time period of the switching element 121 to be shorter than the off-time period. The control circuit 13 repeats the switching operation of the switching element 121 described above. As a result, the current decrease amount of the load current Io is suppressed not to exceed ΔId11, and the value of the output voltage Vo gradually increases, and reaches the sum (Va1+Va2) of the first load voltage value Va1 and the second load voltage value Va2 eventually. In FIG. 8B, the switching operation of the switching element 121 is started at a time point t31, and thus the capacitor 110 is charged gradually. After charge time T31 passes from the time point t31, the value of the output voltage Vo increases to the sum (Va1+Va2) of the first load voltage value Va1 and the second load voltage value Va2.

After that, the control circuit 13 keeps the value of the driving voltage Vg(121) equal to 0 [V] to turn off the switching element 121, thereby turning on both the first light source block 21 and the second light source block 22.

In switching the state of the illumination load 2 from the second state to the first state, the control circuit 13 can perform the switching operation of the switching element 121 with a predetermined period a predetermined number of times. The period and the number of times can be determined so that switching of the switching element 121 is performed over the charge time T31 to allow suppressing the current decrease amount of the load current Io and increasing the value of the output voltage Vo from (Va1+Von) to (Va1+Va2).

Additionally, the control circuit 13 may measure the value of the output voltage Vo. In this regard, in switching the state of the illumination load 2 from the second state to the first state, the control circuit 13 switches the switching element 121 from the on-state to the off-state when an amount of decrease in the output voltage Vo in a condition where the switching element 121 is on (a difference between values of the output voltage Vo before and after decrease in the output voltage Vo) reaches a predetermined value during the switching operation of the switching element 121. The control circuit 13 repeats turning on and off the switching element 121 as described above until the value of the output voltage Vo increases from (Va1+Von) to (Va1+Va2).

Accordingly, while switching the second light source block 22 (the LEDs 220) from the extinguished state to the lighting state, the lighting device 1 can more suppress instant decrease in luminance of the illumination load 2.

### Embodiment 2

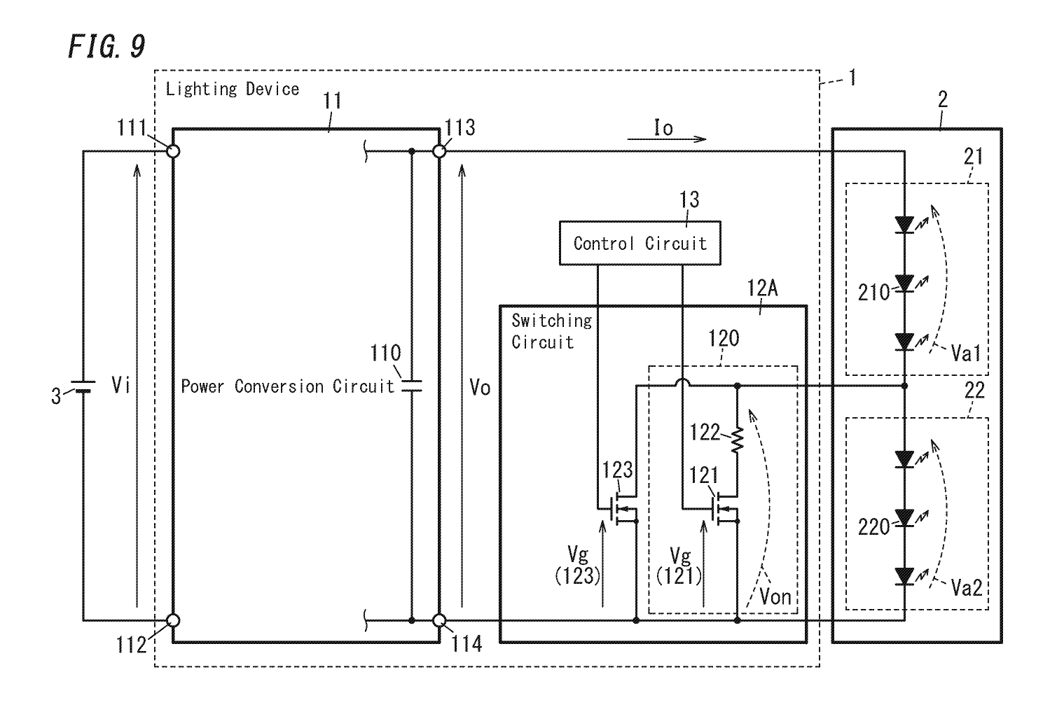

FIG. 9 shows block configurations of a lighting device 1 of EMBODIMENT 2. The lighting device 1 of EMBODIMENT 2 includes a switching circuit 12A as an alternative to the switching circuit 12 of EMBODIMENT 1. The switching circuit 12A includes a switching element 123 in addition to the components of the switching circuit 12. In FIG. 9, the switching element 123 is an N-channel enhancement MOSFET. Note that, the switching element 123 may be any other transistor such as an IGBT. Remaining components of EMBODIMENT 2 are same as or similar to those of EMBODIMENT 1 and components same as or similar to those of EMBODIMENT 1 are designated by the same reference signs.

Note that, in the present embodiment, the switching element 121 corresponds to a first switching element, and the switching element 123 corresponds to a second switching element.

The switching element 123 is electrically coupled in parallel with the second light source block 22. A drain of the switching element 123 is electrically connected to the anode side of the second light source block 22. A source of the switching element 123 is electrically connected to the cathode side of the second light source block 22.

A driving voltage applied to a gate of the switching element 123 is designated by Vg(123). The control circuit 13 can turn on and off the switching element 123 by controlling a value of the driving voltage Vg(123). When the value of the driving voltage Vg(123) is equal to a threshold voltage (on-threshold voltage) of the switching element 123, an electric path is made between the drain and source of the switching element 123, and thereby the switching element 123 is turned to its on-state. When the value of the driving voltage Vg(123) is equal to 0 [V], the electric path is broken between the drain and source of the switching element 123, and thereby the switching element 123 is turned to its off-state.

The control circuit 13 controls the individual values of the driving voltage Vg(121) and the driving voltage Vg(123) to 0 [V] to turn off the individual switching elements 121 and 123, thereby turning on both the first light source block 21 and the second light source block 22. In this situation, the load current Io flows through the first light source block 21 and the second light source block 22 but does not flow through the switching circuit 12A. Thus, both the first light source block 21 and the second light source block 22 are turned on. This state where the first light source block 21 and the second light source block 22 both are on corresponds to a first state of the illumination load 2.

The control circuit 13 controls the individual values of the driving voltage Vg(121) and the driving voltage Vg(123) to be equal to or larger than the corresponding on-threshold values to keep the switching element 121 and the switching element 123 on so that the first light source block 21 is lit and the second light source block 22 is extinguished. In this situation, the load current Io flows through the first light source block 21 and the switching element 123, but does not flow through the second light source block 22. Thus, the first light source block 21 is turned on and the second light source block 22 is turned off. This state where the first light source block 21 is on and the second light source block 22 is off corresponds to a second state of the illumination load 2. Note that, while both the switching element 121 and the switching element 123 are on, the resistor 122 limits a flow of a current through the switching element 121. Therefore, it may be considered that the load current Io flows through the switching element 123 only and a current flowing through the switching element 121 is 0.

Additionally, the power conversion circuit 11 keeps the value of the load current Io equal to the constant current target value Io1 and therefore the value of the output voltage Vo is equal to the first load voltage value Va1 while only the first light source block 21 is on (the second state). In this regard, while the switching element 123 is on, the value of the voltage across the switching element 123 is considerably smaller than the first load voltage value Va1 and therefore the value of the voltage across the switching element 123 in its on-state can be considered to be 0.

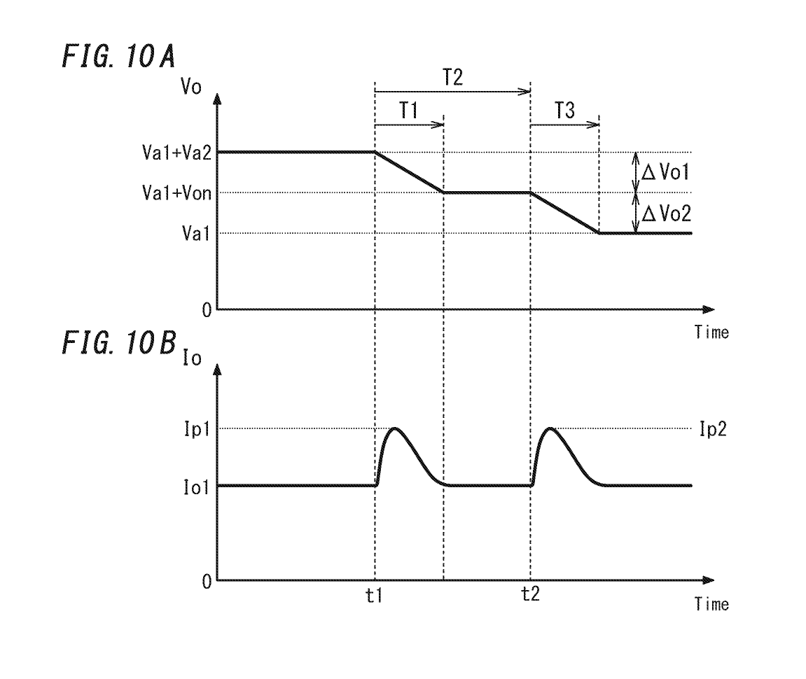

First, descriptions referring to FIG. 10A and FIG. 10B are given to operation of switching the state of the illumination load 2 from the first state where both the first light source block 21 and the second light source block 22 are on to the second state where the first light source block 21 is on and the second light source block 22 is off. FIG. 10A shows a waveform of the output voltage Vo. FIG. 10B shows a waveform of the load current Io.

Like EMBODIMENT 1, the control circuit 13 switches the switching element 121 from the off-state to the on-state (a time point t1). As a result, the value of the output voltage Vo decreases from the sum (Va1+Va2) of the first load voltage value Va1 and the second load voltage value Va2 to the sum (Va1+Von) of the first load voltage value Va1 and the on-voltage value Von.

However, in this situation, the load current Io flows through the resistor 122 and therefore power loss in the resistor 122 may occur. In consideration of this, after predetermined time T2 (first predetermined time) passes from a point of time (the time point t1) at which the switching element 121 is switched from the off-state to the on-state, the control circuit 13 switches the switching element 123 from the off-state to the on-state (a time point t2). In FIG. 10A, the switching element 123 is turned on at the time point t2 and thereby the capacitor 110 further discharges. At a point of time after discharge time T3 passes from the time point t2, the value of the output voltage Vo decreases to the first load voltage value Va1. Note that, the predetermined time T2 is preliminarily set to be longer than the discharge time T1. Hence, after the value of the output voltage Vo decreases to the sum (Va1+Von) of the first load voltage value Va1 and the on-voltage value Von, the switching element 123 is turned on.

Consequently, in the second state where the first light source block 21 is on and the second light source block 22 is off, a value of a current flowing through the resistor 122 decreases due to turning on the switching element 123. This may lead to decrease in power loss in the resistor 122. As a result, power loss in the lighting device 1 can be suppressed.

Further, in FIG. 10A corresponding to the present embodiment, a voltage difference between the sum (Va1+Von) of the first load voltage value Va1 and the on-voltage value Von and the first load voltage value Va1 is defined as ΔVo2 (=Von). Further, in FIG. 3A corresponding to the comparative example, a voltage difference between the sum (Va1+Va2) of the first load voltage value Va1 and the second load voltage value Va2 and the first load voltage value Va1 is defined as ΔVo100 (=Va2). Since the on-voltage value Von is smaller than the second load voltage value Va2, the voltage difference ΔVo2 is also smaller than the voltage difference ΔVo100. In summary, an amount of energy discharged from the capacitor 110 when the switching element is switched from the off-state to the on-state is smaller in the present embodiment than in the comparative example.

As a result, the value of the load current Io shows a rapid and drastic increase directly after the switching element 123 is turned on. However, in this situation, a current peak value Ip2 is smaller than the current peak value Ip101 shown in FIG. 3B.

In the present embodiment, when the switching element 121 is turned on and when the switching element 123 is turned on, the current peak values Ip1 and Ip2 can be seen in the load current Io respectively. However, the voltage differences ΔVo1 and ΔVo2 caused when the switching element 121 is turned on and when the switching element 123 is turned on, respectively, are smaller than the voltage difference ΔVo100 of the comparative example. As a result, the current peak values Ip1 and Ip2 are smaller than the current peak value Ip101 of the comparative example, and this may lead to suppression of occurrence of failures of the LEDs 210.

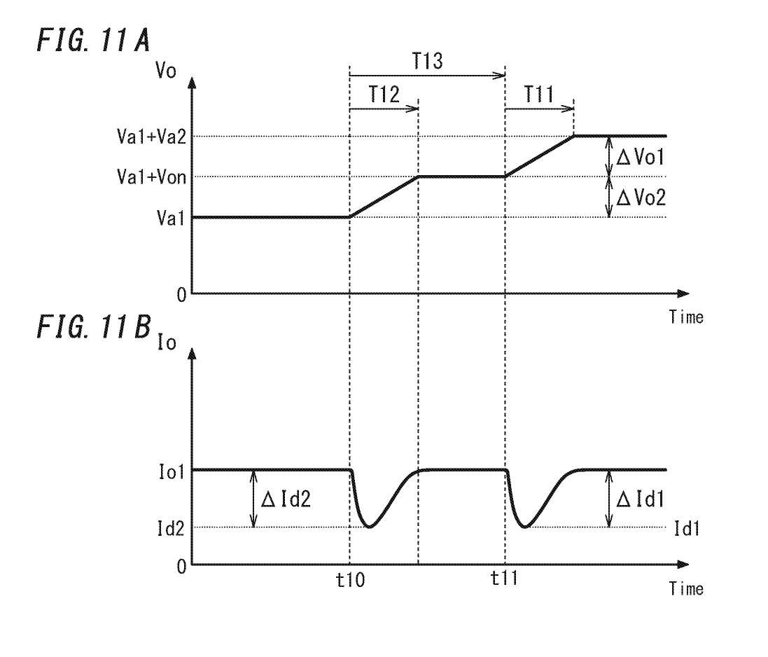

Next, descriptions referring to FIG. 11A and FIG. 11B are given to operation of switching the state of the illumination load 2 from the second state where the first light source block 21 is on and the second light source block 22 is off to the first state where both the first light source block 21 and the second light source block 22 are on. FIG. 11A shows a waveform of the output voltage Vo. FIG. 11B shows a waveform of the load current Io.

The control circuit 13 controls the individual values of the driving voltage Vg(121) and the driving voltage Vg(123) to be equal to or larger than their on-threshold voltage to keep the switching element 121 and the switching element 123 on so that the first light source block 21 is lit and the second light source block 22 is extinguished. In this situation, the value of the output voltage Vo is equal to the first load voltage value Va1, and the value of the load current Io is controlled to be equal to the constant current target value Io1.

Thereafter, the control circuit 13 changes the value of the driving voltage Vg(123) from the on-threshold voltage to 0 [V], thereby switching the switching element 123 from the on-state to the off-state (a time point t10). When the switching element 123 is switched from the on-state to the off-state, the load current Io flows through the switch unit 120 and therefore the value of the output voltage Vo increases from the first load voltage value Va1 to the sum (Va1+Von) of the first load voltage value Va1 and the on-voltage value Von. In FIG. 11B, the switching element 123 is turned off at the time point t10 and thereby the capacitor 110 is charged. At a point of time after charge time T12 passes from the time point t10, the value of the output voltage Vo increases to the sum (Va1+Von) of the first load voltage value Va1 and the on-voltage value Von.

In this regard, in FIG. 11A corresponding to the present embodiment, the voltage difference between the sum (Va1+Von) of the first load voltage value Va1 and the on-voltage value Von and the first load voltage value Va1 is ΔVo2. Further, in FIG. 4A corresponding to the comparative example, the voltage difference between the sum (Va1+Va2) of the first load voltage value Va1 and the second load voltage value Va2 and the first load voltage value Va1 is ΔVo100. As described above, since the voltage difference ΔVo2 is smaller than the voltage difference ΔVo100, an amount of energy for compensating for shortage in energy stored in the capacitor 110 when the switching element is switched from the on-state to the off-state is smaller in the present embodiment than in the comparative example.

As a result, the value of the load current Io instantly decreases to a current minimum value Id2 directly after the switching element 123 is turned off. However, a current decrease amount ΔId2 defined as an amount of decrease in the load current Io is smaller than a current decrease amount ΔId100 defined as an amount of decrease in the load current Io shown in FIG. 4B. In summary, in the present embodiment, the amount of the decrease in the load current Io which occurs immediately after the switching element 123 is turned off can be made to be smaller than that in the comparative example, and therefore instant decrease in luminance of the illumination load 2 can be suppressed.

Additionally, after predetermined time T13 passes from a point of time (the time point t10) at which the switching element 123 is switched from the on-state to the off-state, the control circuit 13 switches the switching element 121 from the on-state to the off-state (the time point t11). Operations after the time point t11 are same as those in EMBODIMENT 1 and therefore explanations thereof are omitted. Note that, the predetermined time T13 is preliminarily set to be longer than the charge time T12. Hence, after the value of the output voltage Vo increases to the sum (Va1+Von) of the first load voltage value Va1 and the on-voltage value Von, the switching element 121 is turned off.

In the present embodiment, when the switching element 121 is turned off or when the switching element 123 is turned off, a drop in the load current Io may occur. However, the voltage difference ΔVo1 caused when the switching element 121 is turned off and the voltage difference ΔVo2 caused when the switching element 123 is turned off are each smaller than the voltage difference ΔVo100 of the comparative example. Consequently, the current decrease amounts ΔId1 and ΔId2 are smaller than the current decrease amount ΔId100 of the comparative example, and instant decrease in luminance of the illumination load 2 can be suppressed.

As described above, in switching between the on-state and the off-state the second light source block 22 of the first light source block 21 and the second light source block 22 coupled in series with each other, the lighting device 1 of EMBODIMENT 2 changes the value of the output voltage Vo step-by-step. Therefore, a loss in the lighting device 1 can be reduced, and the overcurrent state of the load current Io and instant decrease in luminance of the illumination load 2 can be more suppressed.

Note that, the resistance of the resistor 122 may be preferably predetermined so that the current peak value Ip1 observed when the switching element 121 is turned on is almost equal (or equal) to the current peak value Ip2 observed when the switching element 123 is turned on (that is, a difference between the current peak value Ip1 and the current peak value Ip2 is equal to or smaller than a predetermined value). When the resistance of the resistor 122 is set as above, effects of suppressing a current peak value can be improved.

Additionally, the resistance of the resistor 122 may be preferably predetermined so that the current decrease amount ΔId1 observed when the switching element 121 is turned on is almost equal (or equal) to the current decrease amount ΔId2 observed when the switching element 123 is turned on (that is, a difference between the current decrease amount ΔId1 and the current decrease amount ΔId2 is equal to or smaller than a predetermined value). When the resistance of the resistor 122 is set as above, effects of suppressing decrease in an amount of a current can be improved.

Note that, the control circuit 13 includes a computer, for example. The computer includes a device including one or more processors for executing one or more programs, an interface device for sending and receiving signals to and from other devices, and a storing device for storing programs and data. The device with one or more processors may be a central processing unit (CPU) or a micro processing unit (MPU) separate from a storing device, or a microcomputer (MC) incorporating a storing device therein. A storing device may be a storage device with short access time such as a semiconductor memory. Programs may be preliminarily stored in a recording medium such as a computer readable read only memory (ROM) or optical disk, or be sent to a recording medium through a wide area network such as the Internet.

When the computer executes the program, the control circuit 13 controls the switching circuit 12 or 12A. Note that, the control circuit 13 may be constituted by a combination of discrete parts.

The lighting devices 1 mentioned in the above individual embodiments may be used in a lamp such as a vehicle headlamp (headlight) for a vehicle, for example. In the vehicle headlamp, LEDs may be used in place of an incandescent lamp such as a halogen lamp.

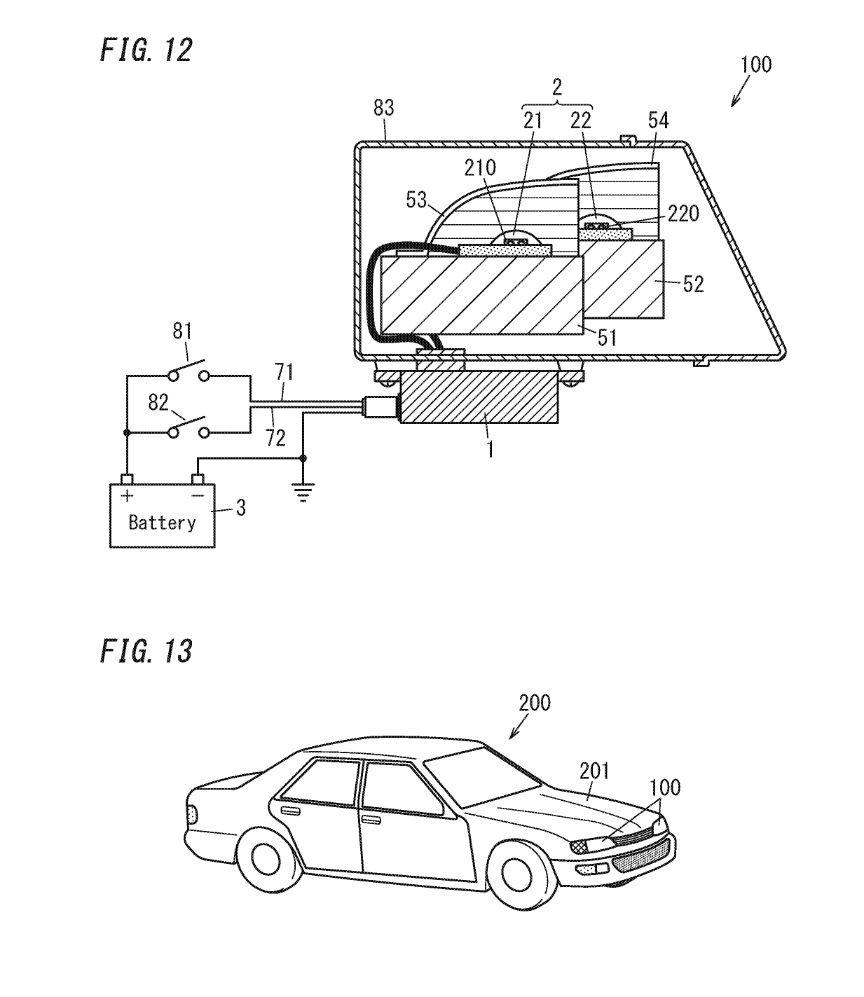

FIG. 12 shows configurations of the vehicle headlamp 100. Note that, the lighting device 1 may be used in a lamp other than a vehicle headlamp, and applications of the lighting device 1 are not limited to vehicle headlamps.

The vehicle headlamp 100 includes a heat sink 51 where the first light source block 21 is mounted and a heat sink 52 where the second light source block 22 is mounted. Additionally, the vehicle headlamp 100 includes a reflection plate 53 for controlling distribution of a light output from the first light source block 21 and a reflection plate 54 for controlling distribution of a light output from the second light source block 22. The heat sinkers 51 and 52 and the reflection plates 53 and 54 are accommodated in a lamp body 83. The lighting device 1 is installed on a lower face of the lamp body 83. The lighting device 1 is supplied with power from a vehicle battery serving as the DC power supply 3 through a power supply line 71.

In this regard, a power supply switch 81 for starting and stopping power supply to the lighting device 1 is interposed in the power supply line 71 coupled to a positive output of the DC power supply 3. Further, an on-off switch 82 is interposed in a signal line 72 interconnecting the positive output of the DC power supply 3 and the lighting device 1. The on-off switch 82 functions as a controller for switching the second light source block 22 between the on-state and the off-state. The individual switching elements 121 and 123 can be switched between the on-state and the off-state by switching the on-off switch 82 between the on-state and the off-state. In summary, the signal line 72 is coupled to the control circuit 13, and the control circuit 13 operates to switch the switching elements 121 and 123 between the on-state and the off-state depending on whether the on-off switch 82 is in the on-state or the off-state.

In this vehicle headlamp 100, the first light source block 21 serves as a passing headlamp (low beam), and the second light source block 22 serves as a running headlamp (high beam). Therefore, the lighting device 1 can select either using a passing headlamp only or using both a passing headlamp and a running headlamp, by switching the second light source block 22 between the on-state and the off-state in accordance with operation of the on-off switch 82. The lighting devices 1 according to the aforementioned embodiments are suitable for applications of selecting one of two types of distribution patterns which are a distribution pattern for a passing headlamp only, and a distribution pattern for both a passing headlamp and a running headlamp. Note that, the vehicle headlamp 100 may not be limited to having two types of distribution patterns which are a distribution pattern for a passing headlamp only and a distribution pattern for both a passing headlamp and a running headlamp, but may have one or more additional distribution patterns according to a running state depending on a vehicle.

FIG. 11 shows a perspective view of appearance of a vehicle 200 where a pair of the aforementioned vehicle headlamps 100 is mounted as left and right headlamps. Note that, the lamp including the lighting device 1 may not be limited to the vehicle headlamp 100 but may be a tail lamp of the vehicle 200 or any other lamp.

Note that, the light sources included in the illumination load 2 are not limited to LEDs 210 and 220, but may be selected from any other solid light emitting devices such as organic electro luminescence (OEL) devices and semiconductor lasers such as a laser diode (LD).

As described above, the lighting device 1 of the first aspect derived from the embodiments is for lighting the illumination load 2 in which the first light source block 21 including one or more LEDs 210 (first light sources) and the second light source block 22 including one or more LEDs 220 (second light sources) are coupled in series with each other. The lighting device 1 includes the power conversion circuit 11, the switching circuit 12 (or 12A), and the control circuit 13. The power conversion circuit 11 is configured to supply the DC load current Io to the illumination load 2. The switching circuit 12 (or 12A) includes the switch unit 120 to be coupled in parallel with the second light source block 22. The switch unit 120 includes the series circuit of the switching element 121 and the resistor 122. The control circuit 13 is configured to keep the switching element 121 off to change the state of the illumination load 2 to the first state, and to keep the switching element 121 on to change the state of the illumination load 2 to the second state. The first state is a state where the first light source block 21 and the second light source block 22 are lit. The second state is a state where the first light source block 21 is lit and the second light block 22 is extinguished. The resistance of the resistor 122 is set to allow the on-voltage value Von defining a value of a voltage across the switch unit 120 to be smaller than a value of a voltage across the second light source block 22 which causes the second light source block 22 to start lighting while the switching element 121 is on.

Consequently, the lighting device 1 can suppress an overcurrent state of the load current Io and instant decrease in luminance which would otherwise occur when switching between on and off states the LEDs 220 (the second light source block 22) which are one or more light sources of the LEDs 210 and the LEDs 220 which are a plurality of light sources coupled in series with each other. Further, the lighting device 1 can suppress, when turning off the LEDs 220, the LEDs 220 from causing slight light emission.

Further, in the lighting device 1 of the second aspect derived from the embodiments would be realized in combination with the first aspect, the control circuit 13 may be preferably configured to turn on and off the switching element 121 at least one time during transition of the state of the illumination load 2 from the first state to the second state.

As a result, the lighting device 1 can more reduce the current peak value of the load current Io in switching the second light source block 22 (the LEDs 220) from the lighting state to the extinguished state.

Further, in the lighting device 1 of the third aspect derived from the embodiments would be realized in combination with the second aspect, the control circuit 13 may be preferably configured to provide the first switching time period during transition of the state of the illumination load 2 from the first state to the second state. In the first switching time period, the control circuit 13 turns on and off the switching element 121 so that the off-time period and the on-time period of the switching element 121 occur alternately.

Further, in the lighting device 1 of the fourth aspect derived from the embodiments would be realized in combination with the third aspect, in the first switching time period, the off-time period may preferably be shorter than the on-time period.

Further, in the lighting device 1 of the fifth aspect derived from the embodiments would be realized in combination with any one of the first to fourth aspects, the control circuit 13 may be preferably configured to turn on and off the switching element 121 at least one time during transition of the state of the illumination load 2 from the second state to the first state.

As a result, the lighting device 1 can more suppress instant decrease in luminance of the illumination load 2 in switching the second light source block 22 (the LEDs 220) from the extinguished state to the lighting state.

Further, in the lighting device 1 of the sixth aspect derived from the embodiments would be realized in combination with the fifth aspect, the control circuit 13 may be preferably configured to provide the second switching time period during transition of the state of the illumination load 2 from the second state to the first state. In the second switching time period, the control circuit 13 turns on and off the switching element 121 so that the off-time period and the on-time period of the switching element 121 occur alternately.

Further, in the lighting device 1 of the seventh aspect derived from the embodiments would be realized in combination with the sixth aspect, in the second switching time period, the on-time period may preferably be shorter than the off-time period.

Further, in the lighting device 1 of the eighth aspect derived from the embodiments would be realized in combination with any one of the first to seventh aspects, the switching element 121 is defined as a first switching element. The switching circuit 12A may preferably further include the switching element 123 serving as a second switching element coupled in parallel with the second light source block 22.

As a result, the lighting device 1 can change the value of the output voltage Vo step-by-step when switching between the lighting state and the extinguished state the second light source block 22 of the first light source block 21 and the second light source block 22 connected in series with each other. Accordingly, a loss in the lighting device 1 can be reduced. Further, it is possible to more suppress the overcurrent state of the load current Io and the instant decrease in the luminance of the illumination load 2.

Further, in the lighting device 1 of the ninth aspect derived from the embodiments would be realized in combination with the eighth aspect, the control circuit 13 may be preferably configured to turn on the switching element 123 after the predetermined time T2 (first predetermined time) passes from turning on the switching element 121 in switching the state of the illumination load 2 from the first state to the second state.

As a result, in the second state where the first light source block 21 lights and the second light source block 22 is extinguished, the lighting device 1 keeps the switching element 123 on and thus a current flowing through the resistor 122 is decreased. Therefore, a power loss in the resistor 122 is reduced. Consequently, a power loss in the lighting device 1 is suppressed.

Further, in the lighting device 1 of the tenth aspect derived from the embodiments would be realized in combination with the ninth aspect, the predetermined time T2 (first predetermined time) may be preferably set to be longer than time (charge time T1) necessary for the output voltage Vo of the power conversion circuit 11 to decrease to a predetermined value after the first switching element 121 is turned on.

Further, in the lighting device 1 of the eleventh aspect derived from the embodiments would be realized in combination with the ninth or tenth aspect, the resistance of the resistor 122 may be preferably set so that a difference between a value of a peak in the load current Io (the current peak value Ip1) which occurs when the first switching element 121 is turned on and a value of a peak in the load current Io (the current peak value Ip2) which occurs when the second switching element 123 is turned on is equal to or smaller than a predetermined value.

Further, in the lighting device 1 of the twelfth aspect derived from the embodiments would be realized in combination with any one of the eighth to eleventh aspects, the control circuit 13 may be preferably configured to turn off the switching element 121 after the predetermined time T13 (second predetermined time) from turning off the switching element 123 in switching the state of the illumination load 2 from the second state to the first state.

As a result, the lighting device 1 can reduce an amount of decrease in the load current Io observed directly after the switching element 123 is turned off, relative to the comparative example. Therefore, instant decrease in luminance of the illumination load 2 can be suppressed.

Further, in the lighting device 1 of the thirteenth aspect derived from the embodiments would be realized in combination with the twelfth aspect, the predetermined time T13 (second predetermined time) may preferably be set to be longer than time (charge time T12) necessary for the output voltage Vo of the power conversion circuit 11 to increase to a predetermined value after the first switching element 121 is turned off.

Further, in the lighting device 1 of the fourteenth aspect derived from the embodiments would be realized in combination with the twelfth or thirteenth aspect, the resistance of the resistor 122 may preferably be set so that a difference between an amount of decrease in the load current Io (the current decrease amount ΔId1) which occurs when the first switching element 121 is turned off and an amount of decrease in the load current Io (the current decrease amount ΔId2) which occurs when the second switching element 123 is turned off, is equal to or smaller than a predetermined value.

Further, in the lighting device 1 of the fifteenth aspect derived from the embodiments would be realized in combination with any one of the first to fourteenth aspects, the one or more first light sources and the one or more second light sources each may preferably be a solid light emitting device.

As a result, the lighting device 1 is applicable to an illuminating device including solid light emitting devices such as LEDs, organic EL devices, and semiconductor lasers.

Further, the vehicle headlamp 100 of the sixteenth aspect derived from the embodiments includes the lighting device 1 according to any one of the aforementioned first to fifteenth aspects, the lamp body 83 where the lighting device 1 is attached, and the illumination load 2 to be lit by the lighting device 1.

Accordingly, the vehicle headlamp 100 includes the lighting device 1. Therefore, the vehicle headlamp 100 can suppress an overcurrent state of the load current Io and instant decrease in luminance which would otherwise occur when switching between on and off states the LEDs 220 (the second light source block 22) which are one or more light sources of the LEDs 210 and the LEDs 220 which are a plurality of light sources coupled in series with each other. Further, the vehicle headlamp 100 can suppress, when turning off the LEDs 220, the LEDs 220 from causing slight light emission.

Further, the vehicle 200 of the seventeenth aspect derived from the embodiments includes the vehicle headlamp 100 according to the aforementioned sixteenth aspect; and the vehicle body 201 where the vehicle headlamp 100 is mounted.

Accordingly, the vehicle 200 includes the vehicle headlamp 100. Therefore, the vehicle 200 can suppress an overcurrent state of the load current Io and instant decrease in luminance which would otherwise occur when switching between on and off states the LEDs 220 (the second light source block 22) which are one or more light sources of the LEDs 210 and the LEDs 220 which are a plurality of light sources coupled in series with each other. Further, the vehicle 200 can suppress, when turning off the LEDs 220, the LEDs 220 from causing slight light emission.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

1. A lighting device for lighting an illumination load in which a first light source block including one or more first light sources and a second light source block including one or more second light sources are coupled in series with each other,
the lighting device comprising:
a power conversion circuit configured to supply a DC load current to the illumination load;
a switching circuit including a switch unit configured to be coupled in parallel with the second light source block; and
a control circuit,
wherein:
the switch unit includes a series circuit of a switching element and a resistor;
the control circuit is configured to keep the switching element off to change a state of the illumination load to a first state, the first state being a state of the illumination load where the first light source block and the second light source block are lit;
the control circuit is configured to keep the switching element on to change the state of the illumination load to a second state, the second state being a state of the illumination load where the first light source block is lit and the second light source block is extinguished; and
a resistance of the resistor is set to allow a value of a voltage across the switch unit to be smaller than a value of a voltage across the second light source block which causes the second light source block to start lighting while the switching element is on.

2. The lighting device according to claim 1, wherein
the control circuit is configured to turn on and off the switching element at least one time during transition of the state of the illumination load from the first state to the second state.

3. The lighting device according to claim 2, wherein
the control circuit is configured to turn on and off the switching element to provide a first switching time period in which an off-time period and an on-time period of the switching element occur alternately during transition of the state of the illuminating load from the first state to the second state.

4. The lighting device according to claim 3, wherein
in the first switching time period, the off-time period is shorter than the on-time period.

5. The lighting device according to claim 1, wherein
the control circuit is configured to turn on and off the switching element at least one time during transition of the state of the illumination load from the second state to the first state.

6. The lighting device according to claim 5, wherein
the control circuit is configured to turn on and off the switching element to provide a second switching time period in which an off-time period and an on-time period of the switching element occur alternately during transition of the state of the illumination load from the second state to the first state.

7. The lighting device according to claim 6, wherein
in the second switching time period, the on-time period is shorter than the off-time period.

8. The lighting device according to claim 1, wherein:
the switching element is defined as a first switching element; and
the switching circuit further includes a second switching element coupled in parallel with the second light source block.

9. The lighting device according to claim 8, wherein
the control circuit is configured to turn on the second switching element after first predetermined time passes from turning on the first switching element in switching the state of the illumination load from the first state to the second state.

10. The lighting device according to claim 9, wherein:
the first predetermined time is set to be longer than time necessary for the output voltage of the power conversion circuit to decrease to a predetermined value after the first switching element is turned on.

11. The lighting device according to claim 9, wherein
the resistance of the resistor is set so that a difference between a value of a peak in the load current which occurs when the first switching element is turned on and a value of a peak in the load current which occurs when the second switching element is turned on is equal to or smaller than a predetermined value.

12. The lighting device according to claim 8, wherein
the control circuit is configured to turn off the first switching element after second predetermined time passes from turning off the second switching element in switching the state of the illumination load from the second state to the first state.

13. The lighting device according to claim 12, wherein:
the second predetermined time is set to be longer than time necessary for the output voltage of the power conversion circuit to increase to a predetermined value after the first switching element is turned off.

14. The lighting device according to claim 12, wherein
the resistance of the resistor is set so that a difference between an amount of decrease in the load current which occurs when the first switching element is turned off and an amount of decrease in the load current which occurs when the second switching element is turned off is equal to or smaller than a predetermined value.

15. The lighting device according to claim 1, wherein
the one or more first light sources and the one or more second light sources each are a solid light emitting device.

16. A vehicle headlamp comprising:
the lighting device according to claim 1;
a lamp body where the lighting device is attached; and
the illumination load to be lit by the lighting device.

17. A vehicle comprising:
the vehicle headlamp according to claim 16; and
a vehicle body where the vehicle headlamp is mounted.
